(19) United States
(12) Patent Application Publication
(10) Pub. No.: US 2024/0311921 A1
(43) Pub. Date: Sep. 19, 2024

(54) GENERATION OF CUSTOMIZED CODE

(71) Applicant: STATE FARM MUTUAL AUTOMOBILE INSURANCE COMPANY, Bloomington, IL (US)

(72) Inventors: Brian Mark Fields, Phoenix, AZ (US); Nathan L. Tofte, Downs, IL (US); Joseph Robert Brannan, Bloomington, IL (US); Vicki King, Bloomington, IL (US); Justin Davis, Bloomington, IL (US)

(21) Appl. No.: 18/462,032

(22) Filed: Sep. 6, 2023

Related U.S. Application Data
(60) Provisional application No. 63/464,073, filed on May 4, 2023.
(60) Provisional application No. 63/464,061, filed on May 4, 2023.
(60) Provisional application No. 63/489,843, filed on Mar. 13, 2023.
(60) Provisional application No. 63/489,852, filed on Mar. 13, 2023.

(51) Int. Cl. G06Q 40/08; H04L 51/02

(52) U.S. Cl. CPC G06Q 40/08; H04L 51/02

(57) ABSTRACT

Apparatuses, systems and methods are provided for generating customized code. The apparatuses, systems and methods may cause a chatbot to generate customized code. The apparatuses, systems and methods may integrate the customized code in an insurance application. The customized code, when executed by one or more processors, may cause the one or more processors to collect user information from a user device, determine whether a change of insurance policy for the user is required, and responsive to determining that a change of insurance policy is required, automatically update the insurance policy in the insurance application based upon the required change.

### CROSS-REFERENCE TO RELATED APPLICATIONS

This application claims priority to and the benefit of the filing date of (1) provisional U.S. Patent Application No. 63/489,843 entitled “GENERATION OF CUSTOMIZED CODE FOR INSURANCE APPLICATIONS,” filed on Mar. 13, 2023, (2) provisional U.S. Patent Application No. 63/464,061 entitled “GENERATION OF CUSTOMIZED CODE FOR INSURANCE APPLICATIONS,” filed on May 4, 2023, (3) provisional U.S. Patent Application No. 63/489,852 entitled “ERROR CHECKING FOR CODE OF INSURANCE APPLICATIONS,” filed on Mar. 13, 2023, and (4) provisional U.S. Patent Application No. 63/464,073 entitled “ERROR CHECKING FOR CODE OF INSURANCE APPLICATIONS,” filed on May 4, 2023. The entire disclosure of each of the above-identified applications is hereby expressly incorporated herein by reference.

### FIELD OF THE INVENTION

The present disclosure generally relates to generating customized code, and more particularly, generating customized code, such as code implementing customized insurance policy, via a machine learning chatbot or an artificial intelligence chatbot.

### BACKGROUND

Insurance is a complex field that depends on many variables, such as customer profile, policy type, coverage options, premium calculations, claims management, and policy compliance. Traditional insurance software solutions may often fail to meet the specific needs and expectations of customers and insurers alike. Further, when customers are experiencing significant life changes, their need for insurance policies may change simultaneously. Traditional insurance software solutions may fail to cater such changed needs efficiently.

The conventional insurance customization techniques may include additional ineffectiveness, inefficiencies, encumbrances, and/or other drawbacks.

### SUMMARY

The present embodiments may relate to, inter alia, systems and methods for generating customized code via a machine learning and/or artificial intelligence chatbot (or voice bot).

In one aspect, a computer system for generating customized using a machine learning (ML) chatbot (or voice bot) or an artificial intelligence (AI) chatbot (or voice bot). The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may comprise one or more processors; and a non-transitory memory storing executable instructions thereon that, when executed by the one or more processors, cause the one or more processors to: (1) detect a request from a user to generate a customized insurance policy, (2) cause a machine learning (ML) chatbot or an artificial intelligence (AI) chatbot to generate customized code to be used in the insurance application, wherein the customized code implements the customized insurance policy, and/or (3) integrate the customized code in the insurance application, wherein the customized code, when executed by the one or more processors, cause the one or more processors to: (a) receive user information from a user's mobile device or other computing device, (b) determine whether a change of insurance policy for the user is required, wherein the insurance policy is comprised in the insurance application, and/or (c) responsive to determining that a change of insurance policy is required, automatically update the insurance policy in the insurance application based upon the required change, and/or (i) create an update to the insurance policy, and/or (ii) send or transmit a proposed update to the insurance policy to the user's mobile device or other computing device for user review, modification, and/or approval. The computer system may include additional, less, or alternate functionality, including that discussed elsewhere herein.

In another aspect, a computer-implemented method for generating customized code using a machine learning (ML) chatbot (or voice bot) or an artificial intelligence (AI) chatbot (or voice bot). The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. For example, in one instance, the computer-implemented method may comprise: (1) detecting a request from a user to generate a customized insurance policy; (2) causing a ML chatbot or an AI chatbot to generate customized code to be used in the insurance application, wherein the customized code implements the customized insurance policy, and/or (3) integrating the customized code in the insurance application, wherein the customized code, when executed by one or more processors, cause the one or more processors to: (a) receive user information from a user's mobile device or other computing device, (b) determine whether a change of insurance policy for the user is required, wherein the insurance policy is comprised in the insurance application, and/or (c) responsive to determining that a change of insurance policy is required, automatically update the insurance policy in the insurance application based upon the required change, and/or (i) create an update to the insurance policy, and/or (ii) send or transmit a proposed update to the insurance policy to the user's mobile device or other computing device for user review, modification, and/or approval. The method may include additional, less, or alternate functionality or actions, including those discussed elsewhere herein.

In another aspect, a non-transitory computer-readable medium storing processor-executable instructions that, when executed by one or more processors, cause the one or more processors to (1) detect a request from a user to generate a customized insurance policy, (2) cause a machine learning (ML) chatbot or an artificial intelligence (AI) chatbot to generate customized code to be used in the insurance application, wherein the customized code implements the customized insurance policy, and/or (3) integrate the customized code in the insurance application, wherein the customized code, when executed by the one or more processors, cause the one or more processors to: (a) receive user information from a user's mobile device or other computing device, (b) determine whether a change of insurance policy for the user is required, wherein the insurance policy is comprised in the insurance application, and/or (c) responsive to determining that a change of insurance policy is required, automatically update the insurance policy in the insurance application based upon the required change, and/or (i) create an update to the insurance policy, and/or (ii) send or transmit a proposed update to the insurance policy to the user's mobile device or other computing device for user review, modification, and/or approval. The instructions may direct additional, less, or alternate functionality, including that discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A depicts a block diagram of an exemplary computer system in which methods and systems for generating customized code are implemented according to one embodiment.

FIG. 1B depicts a block diagram of an exemplary computer system in which methods and systems for generating customized code are implemented according to one embodiment.

FIG. 2 depicts a combined block and logic diagram in which exemplary computer-implemented methods and systems for training an ML chatbot or an AI model are implemented according to one embodiment.

FIGS. 3A-3C depict exemplary displays of an enterprise mobile application employing an ML chatbot or an AI chatbot according to one embodiment.

FIG. 4 depicts a flow diagram of an exemplary computer-implemented method for generating customized code according to one embodiment.

FIG. 5 depicts a flow diagram of an exemplary computer-implemented method for generating customized code according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Exemplary Computing Environment

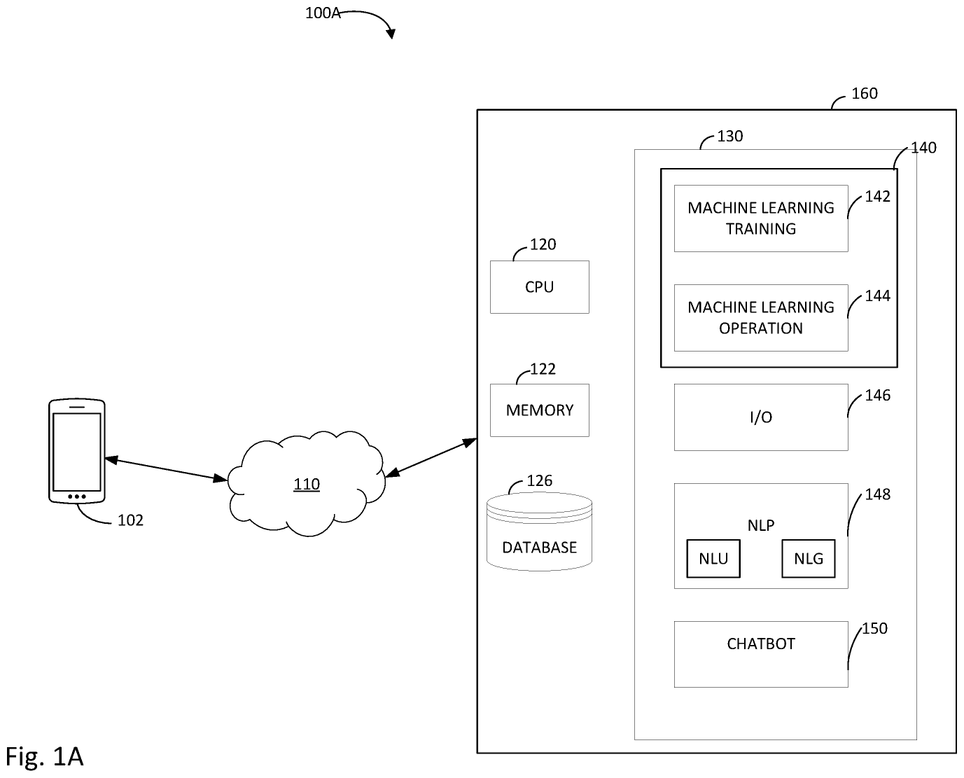

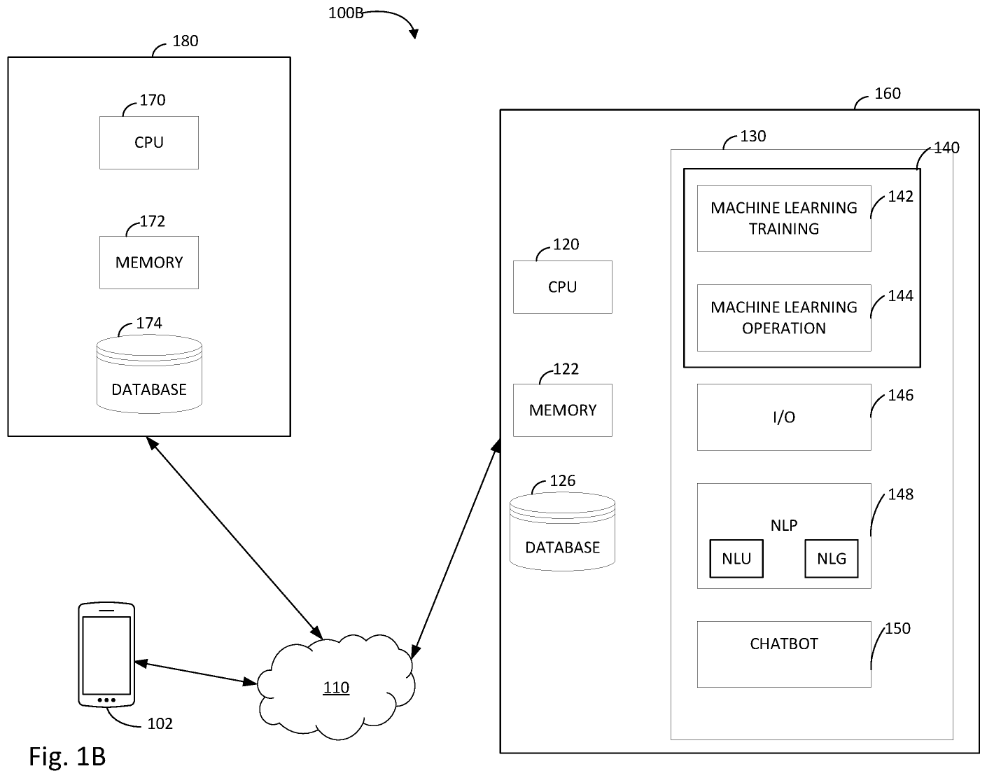

FIG. 1A depicts a block diagram of an exemplary computing environment 100A in which generating customized code may be performed, in accordance with various aspects discussed herein.

In the exemplary aspect of FIG. 1A, the computing environment 100A includes a user device 102. In various aspects, the user device 102 comprises one or more computing devices, which may comprise multiple, redundant, or replicated client computing devices accessed by one or more users. The computing environment 100A may further include an electronic network 110 communicatively coupling other aspects of the computing environment 100A.

The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100A via the network 110.

In one aspect, one or more servers 160 may perform the functionalities as part of a cloud network or may otherwise communicate with other hardware or software components within one or more cloud computing environments to send, retrieve, or otherwise analyze data or information described herein. For example, in certain aspects of the present techniques, the computing environment 100A may comprise an on-premise computing environment, a multi-cloud computing environment, a public cloud computing environment, a private cloud computing environment, and/or a hybrid cloud computing environment. For example, an entity (e.g., a business) providing a chatbot to generate customized code may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by an enterprise generating the customized code. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 3G, 4G, 5G, etc.). Generally, the network 110 enables bidirectional communication between the user device 102 and the servers 160. In one aspect, the network 110 may comprise a cellular base station, such as cell tower(s), communicating to the one or more components of the computing environment 100A via wired/wireless communications based upon any one or more of various mobile phone standards, including NMT, GSM, CDMA, UMMTS, LTE, 5G, 6G, or the like. Additionally or alternatively, the network 110 may comprise one or more routers, wireless switches, or other such wireless connection points communicating to the components of the computing environment 100A via wireless communications based upon any one or more of various wireless standards, including by non-limiting example, IEEE 802.11a/b/c/g (WIFI), Bluetooth, and/or the like.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang. Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data and be used to train and/or operate one or more ML models, chatbots, and/or voice bots.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, support vector machines and generative pre-trained transformers. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 160. For example, libraries may include the TensorFlow based library, the PyTorch library, a HuggingFace library, and/or the scikit-learn Python library.

In one embodiment, the ML module 140 may employ supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with a de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 160 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 160 or may be indirectly accessible via or attached to the user device 102. According to an aspect, an administrator or operator may access the servers 160 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT bot, an InstructGPT bot, a Codex bot, or a Google Bard bot. The voice bot or chatbot 150 may employ supervised or unsupervised ML techniques, which may be followed by, and/or used in conjunction with, reinforced or reinforcement learning techniques. The voice bot or chatbot 150 may employ the techniques utilized for ChatGPT, ChatGPT bot, InstructGPT bot, Codex bot, or Google Bard bot.

Noted above, in some embodiments, a chatbot 150 or other computing device may be configured to implement ML, such that server 160 “learns” to analyze, organize, and/or process data without being explicitly programmed. ML may be implemented through ML methods and algorithms. In one exemplary embodiment, the ML module 140 may be configured to implement ML methods and algorithms.

In one aspect, the server 160 may detect a request from a user to generate a customized insurance policy. The server 160 may process the request and cause a chatbot, such as the chatbot 150, to generate customized code to be used in the insurance application. For example, the server 160 may create, via the NLG functionality 148, a prompt for generating customized code in natural language and transmit the prompt to the chatbot. Alternatively, the server 160 may create, via the NLG functionality 148, a prompt for generating customized code in a code comment format and transmit the prompt to the chatbot 150. Alternatively, the server 160 may receive a request from a user in natural language, process the request via the NLU functionality, and create a prompt in the preceding manners. The request from a user may be in audio format, in text format, and/or image format. Alternatively, the server 160 may process the request via the chatbot 150, and then cause the chatbot 150 to generate customized code according to the request.

In one aspect, the server 160 may integrate the customized code in an insurance application. For example, the server 160 may parse the code of the insurance application, locate the code that implements a current insurance policy for the user (hereinafter, the “target code”), and replace the target code with the customized code generated by the chatbot 150. Alternatively, the server 160 may parse the code of the insurance policy, locate the code that invokes the current insurance policy (hereinafter, the “target invoking code”), replace the target invoking code with code that invokes the customized code generated by the chatbot 150 and add the customized code into the application.

In one aspect, the server 160 may host and/or provide an application (e.g., a mobile application) and/or website configured to provide the application to receive a request for customized insurance policy from a user. In one aspect, the server 160 may store code in memory 122 which when executed by CPU 120 may provide the website and/or application.

In one aspect, the application may use the chatbot 150 to guide the user through a step-by-step question and answer process until a detailed request for customized insurance policy has been captured by the server 160. In one aspect, the server 160 may store the data comprised in the detailed request in the database 126. The data may be cleaned, labeled, vectorized, weighted, and/or otherwise processed for suitable use in any aspect of ML.

In one aspect, when the server 160 implements the customized insurance policy, the associated data may be stored in the database 126. In one aspect, the server 160 may use the stored data to generate, train and/or retrain one or more models of the ML module 140 and/or chatbots 150, and/or for any other suitable purpose.

In operation, ML model training module 142 may access database 126 or any other data source for training data suitable to generate one or more ML models appropriate to receive and/or process the request for customized insurance policy, e.g., as part of an “ML chatbot.” The training data may be sample data with assigned relevant and comprehensive labels (classes or tags) used to fit the parameters (weights) of an ML model with the goal of training it by example. In one aspect, training data may include existing code that implements insurance policy. The training data may further include existing code compliant for use in an insurance application. The training data may further include user profiles, user activity data, insurance policy information, as well as any other suitable training data. In one aspect, once an appropriate ML model is trained and validated to provide accurate predictions and/or responses, the trained ML model may be loaded into MLOM 144 at runtime, may process the user inputs and/or utterances, may generate as an output conversational dialog, and may generated customized code implementing a customized insurance policy.

While various embodiments, examples, and/or aspects disclosed herein may include training and generating one or more chatbots 150 for the server 160 to load at runtime, it is also contemplated that one or more appropriately trained ML chatbots 150 may already exist (e.g., in database 126) such that the server 160 may load an existing trained chatbot 150 at runtime. It is further contemplated that the server 160 may retrain, update and/or otherwise alter an existing chatbot 150 before loading the model at runtime.

Although the computing environment 100A is shown to include one user device 102, one server 160, and one network 110, it should be understood that different numbers of user devices 102, networks 110, and/or servers 160 may be utilized. In one example, the computing environment 100A may include a plurality of servers 160 and hundreds or thousands of user devices 102, all of which may be interconnected via the network 110. Furthermore, the database storage or processing performed by the one or more servers 160 may be distributed among a plurality of servers 160 in an arrangement known as “cloud computing.” This configuration may provide various advantages, such as enabling near real-time uploads and downloads of information as well as periodic uploads and downloads of information.

The computing environment 100A may include additional, fewer, and/or alternate components, and may be configured to perform additional, fewer, or alternate actions, including components/actions described herein. Although the computing environment 100A is shown in FIG. 1A as including one instance of various components such as user device 102, server 160, and network 110, etc., various aspects include the computing environment 100A implementing any suitable number of any of the components shown in FIG. 1A and/or omitting any suitable ones of the components shown in FIG. 1A. For instance, information described as being stored at server database 126 may be stored at memory 122, and thus database 126 may be omitted. Moreover, various aspects include the computing environment 100A including any suitable additional component(s) not shown in FIG. 1A, such as but not limited to the exemplary components described above. Furthermore, it should be appreciated that additional and/or alternative connections between components shown in FIG. 1A may be implemented. As just one example, server 160 and user device 102 may be connected via a direct communication link (not shown in FIG. 1A) instead of, or in addition to, via network 110.

FIG. 1B depicts a block diagram of an exemplary computing environment 100B in which a process of generating customized code may be performed. The user device 102 and the one or more servers 160 of the computing environment 100B configured in a similar manner as described with respect to the computing environment 100A. However, in the computing environment 100B, a server 180 may receive the customized code generated by the server 160 via the network 110 or a direct communication link (not shown in FIG. 1B), and store the customized code in a database 174 for execution by one or more processors 170. As such, in the computing environment 100B, either the server 160 or the server 180 may execute the customized code generated by the server 160 via the chatbot 150. The server 180 may comprise fewer modules than the server 160 and does not have a capability to generate customized code as the server 160.

### Exemplary Training of the Ml Chatbot Model

An enterprise may be able to use programmable chatbots, such as the chatbot 150 and/or an ML chatbot (e.g., ChatGPT), to provide tailored, conversational-like customer service relevant to a line of business. The chatbot may be capable of understanding customer requests, providing relevant information, escalating issues, any of which may assist and/or replace the need for customer service assets of an enterprise. Additionally, the chatbot may generate data from customer interactions which the enterprise may use to personalize future support and/or improve the chatbot's functionality, e.g., when retraining and/or fine-tuning the chatbot.

The ML chatbot may provide advance features as compared to a non-ML chatbot. For example, the ML chatbot may include and/or derive functionality from a large language model (LLM). The ML chatbot may be trained on a server, such as the server 160 of FIG. 1A or the server 180 of FIG. 1B, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user prompts and/or utterances, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in the memory 122 of the server 105) that may be required for immediate use and may keep track of the current state of the conversation and/or to understand the user's latest input in order to generate an appropriate response. Long-term memory may include persistent storage of information (e.g., on database 126 of the server 105) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., via the ML module 140 of the server 105) which may be used the an ML chatbot, may consists of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

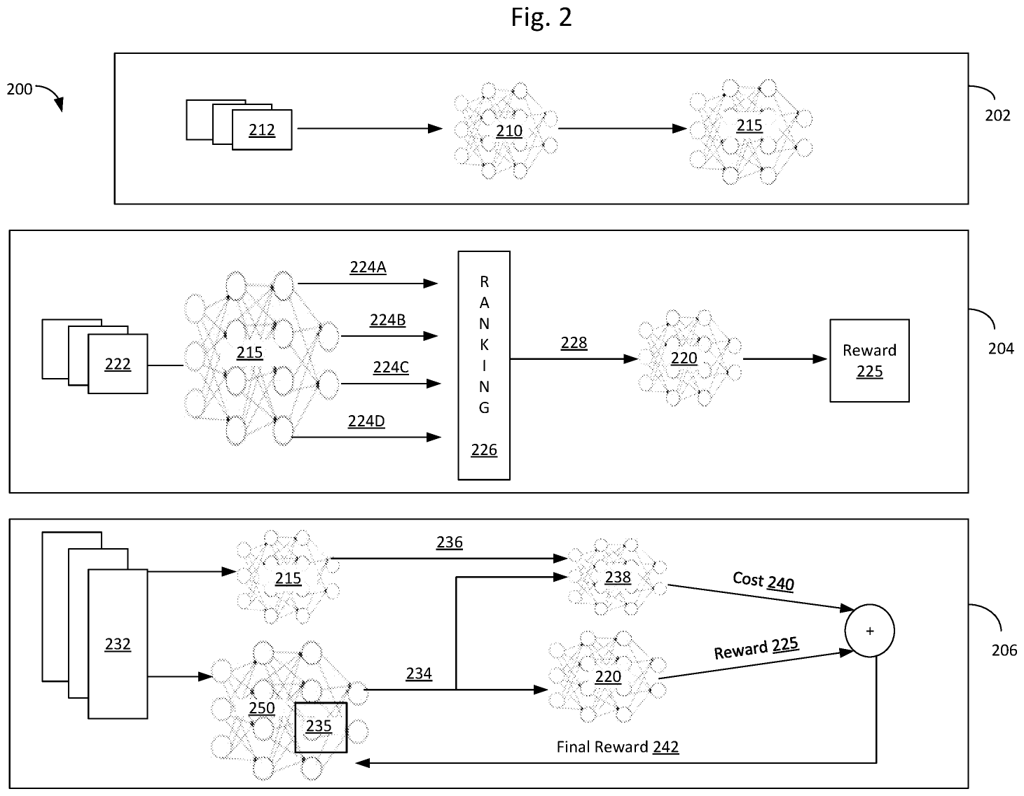

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more servers 202, 204, 206, such as the server 160 of FIG. 1A or the server 180 of FIG. 1B.

In one aspect, the server 202 may fine-tune a pretrained language model 210. The pretrained language model 210 may be obtained by the server 202 and be stored in a memory, such as memory 122 and/or database 126. The pretrained language model 210 may be loaded into an ML training module, such as MLTL 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122 and/or database 126.

In one aspect, the supervised training dataset 212 may include prompts and responses which may be relevant to a user requesting a customized insurance policy with their insurance carrier. For example, a user may request a customized insurance policy in view of his recent and/or expected life events. Appropriate responses may include requesting more details about the user's recent and/or expected life events, recommending a customized insurance policy in view of the changes and data associated with the user, among other things.

In one embodiment, the recommended customized insurance policy may include a non-quantitative suggestion. For example, the input data “moving to a region with lower safety” may be associated with an appropriate response such as “In view of your recent life events, we recommend increasing your insurance policy coverage.” The input data may also be processed to generate medium input data. For example, the input data include moving from zip code A to zip code B. The medium input data include the difference between the safety levels associated with zip code A and zip B. An appropriate response may be associated with the safety level change included in the medium input data. The safety level data associated with zip code A and zip code B may be retrieved from the database 126, or retrieved from various databases available on the Internet in real-time.

In another embodiment, the proposed customized insurance policy may include a quantitative suggestion. For example, in response to a user moving to a less safe region recently, the proposed customized insurance policy may be “In view of your recent life events, we recommend increasing your insurance policy coverage by about 10%.” The model may further communicate with a data analysis module. The data analysis module may be included in the chatbot 150 or in the ML module 140. The data analysis module may be trained by supervised learning, unsupervised learning, semi-supervised learning, and may employ any model that fits for data analysis purposes. As such, a medium response may be associated with an instruction which invokes the data analysis module to determine an appropriate customized insurance policy. For example, the input data include moving from zip code A to zip code B. An appropriate medium response associated with the input data may include detecting a need for data analysis and causing the data analysis module to perform data analysis. In response to receiving an analysis result from the data analysis module, an appropriate response may be generated by combining a conversational response associated with the prompt (e.g., “In view of your recent life events, we recommend ______ your insurance policy coverage by about ______.”) with an output from the data analysis module (e.g., “increase” and “10%”).

In another aspect, the supervised training dataset 212 may include prompts and responses which may be relevant to requesting customized code implementing a customized insurance policy. For example, the server 160 may transmit, via one or more processors 120, a prompt for requesting customized code. An appropriate response associated with the prompt may be customized code consistent with the request.

In one embodiment, the prompt may include existing code implementing a current insurance policy held by the user (i.e., the “target code”). An appropriate response may include customized code consistent with the target code. For example, if the target code is written in Python with a particular function name (e.g., “def policy: code_for_current_policy”), an appropriate response may also be written in Python with the same particular function name (e.g., “def policy: code_for_customized_policy”).

In another embodiment, the prompt may include a recommended customized insurance policy. An appropriate response may be customized code implementing the recommended customized insurance policy.

In yet another embodiment, the prompt may include data associated with the user and/or data associated with the user's recent life events. An appropriate medium response may include detecting a need for data analysis and causing a data analysis module to perform data analysis. In response to receiving a data analysis result from the data analysis module, an appropriate response may be customized code implementing a customized insurance policy consistent with the data analysis result.

### Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B, 224C, 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 236 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### RLHF to Train the ML Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using a cost function 238 to the SFT ML model 215 (which may not use a policy) response 236 of the same prompt 232. The cost function 238 may be trained in a similar manner and/or contemporaneous with the reward model 220. The server 206 may compute a cost 240 based upon the cost function 238 of the responses 234, 236. The cost 240 may reduce the distance between the responses 234, 236, i.e., a statistical distance measuring how one probability distribution is different from a second, in one aspect the response 234 of the ML chatbot model 250 versus the response 236 of the SFT model 215. Using the cost 240 to reduce the distance between the responses 234, 236 may avoid a server over-optimizing the reward model 220 and deviating too drastically from the human-intended/preferred response. Without the cost 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward 225. The ML chatbot model 250 response 234 may be compared via the cost function 238 to the SFT ML model 215 response 236 by the server 206 to compute the cost 240. The server 206 may generate a final reward 242 which may include the scalar reward 225 offset and/or restricted by the cost 240. The final reward 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### Exemplary Graphical User Interface (GUI)

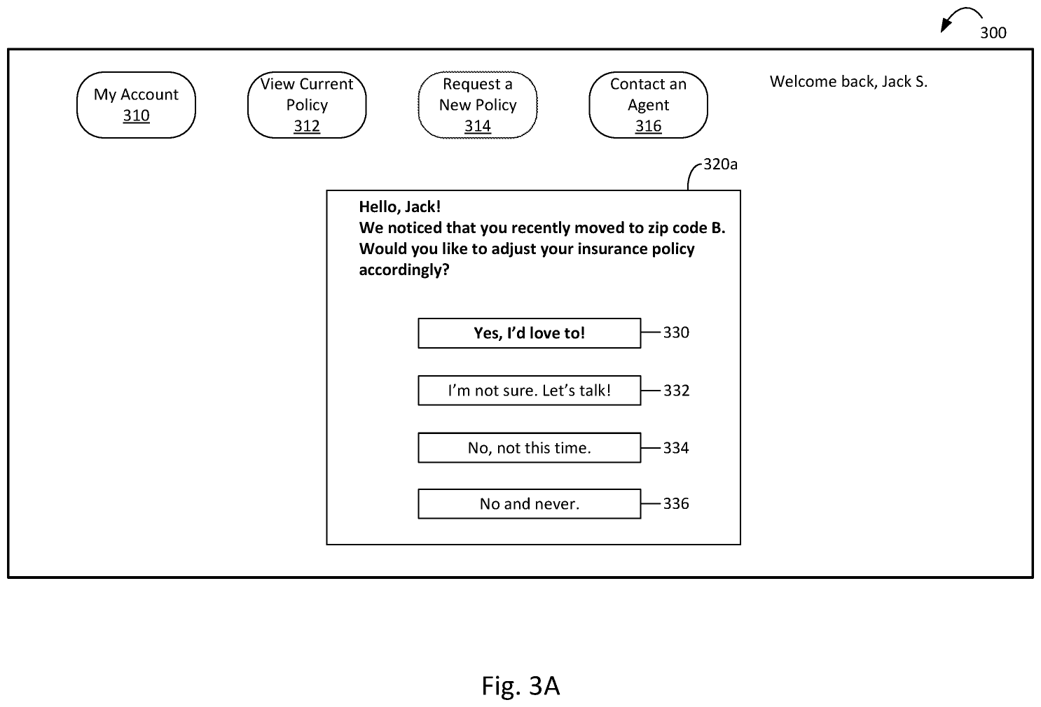

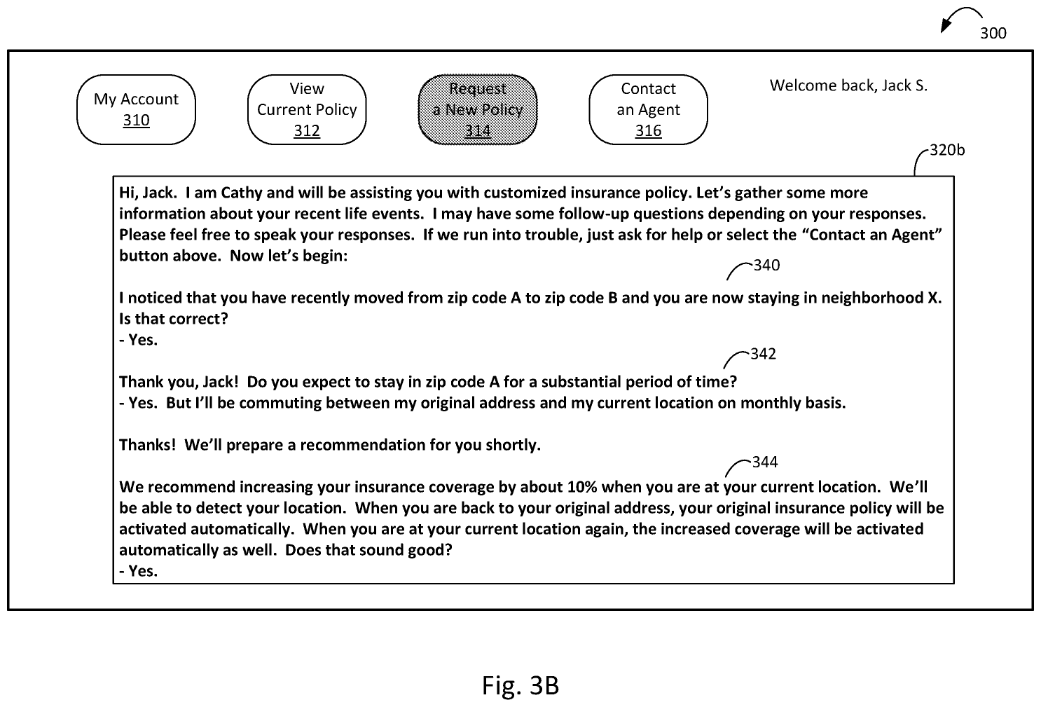

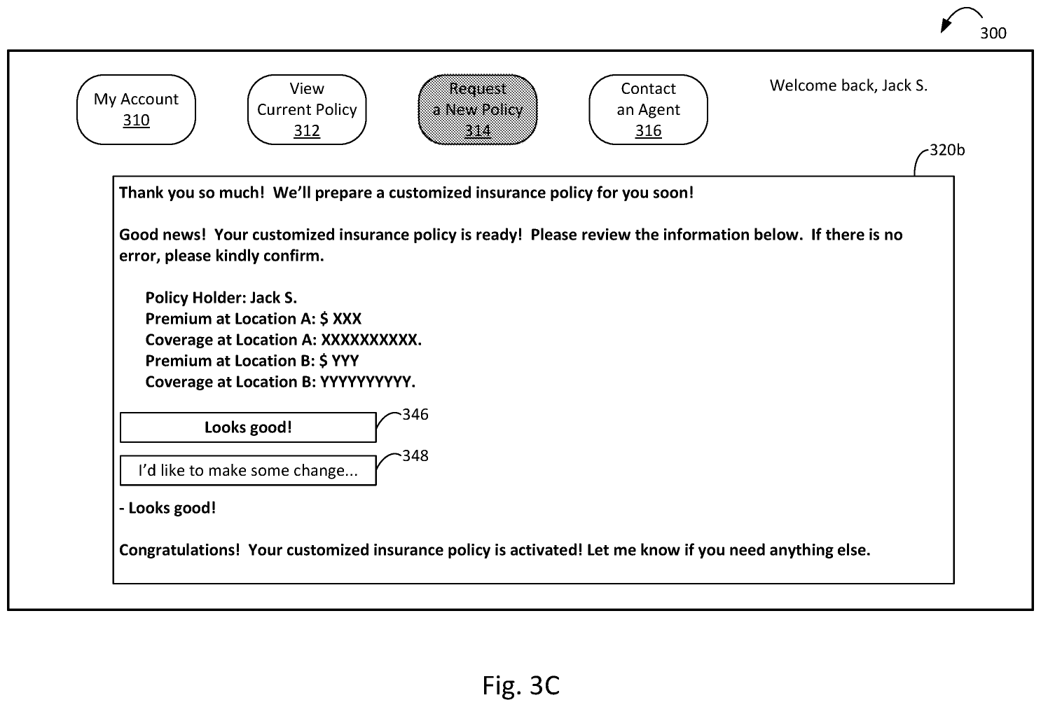

FIGS. 3A-3C depict an exemplary GUI 300 of an enterprise mobile application (app) employing an ML chatbot 330 to request a customized insurance policy, according to one embodiment. The app may be run on a user device 102 communicating with a server 160 via a network 110.

A user may wish to have an insurance policy customized to his needs. In one aspect, the insurance carrier may provide a mobile app which a user may use to request customized insurance policy via their user device 102. In the example of FIGS. 3A-3C, a user (“Jack”) may use his smartphone app to request a customized insurance policy with his insurance carrier due to a vehicle accident.

The user may sign into the application via the user device 102 (e.g., a smartphone, tablet, laptop) using their user credentials, such as a username and password. The user credentials may be transmitted by the user device 102 via a cellular network 110 to the insurance carrier's server 160. The server 160 may verify the user's credentials, e.g., via profile data saved on a database 126. Upon verification of the credentials by the server 160, the app may provide to the user one or more business functions associated with the enterprise, which may include requesting a customized insurance policy.

In one aspect, the user's app may display icons 310, 312, 314, 316 associated with various business functions, wherein the “Request a New Policy” icon 314 may allow the user to request a customized insurance policy by selecting it. In one embodiment, the user may select the icon 314 via the touchscreen of his smartphone or other computing devices. Referring to FIG. 3B, based upon selecting the icon 314, the server 160 may initiate a communication session 320b within the app. The communication session 320b may include one or more of (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing. (v) communication using virtual reality, (vi) communication using augmented reality, (vii) blockchain entries, (vii) communication in the metaverse, and/or any other suitable form of communication. The communication session 320 includes instant messaging, interactive icons, and/or an interactive voice session via which the user is able to type and/or speak his or her natural language responses via the smartphone.

In another embodiment, referring back to FIG. 3A, upon detecting a significant life change of the user, the server 160 may start an initial session 320a via the GUI 300. In response to receiving an indication that the user may be interested in a customized insurance policy (e.g., “I'd love to!” 330 or “I'm not sure. Let's talk!” 332), the server 160 may initiate the communication session 320b shown in FIG. 3B.

The mobile app may request the user provide information relevant to the customized insurance policy (e.g., inquiring the user's current neighborhood 340, inquiring the user's expected activities 342). The relevant information may include one or more of: (i) a type of insurance the user is interested in (e.g., vehicle, property, personal injury, etc.), (ii) user profile information (e.g., gender, age, address, etc.), (iii) user activity data (e.g., health-related activities, etc.) (iv) a coverage scope the user is interested in (e.g., high coverage, medium coverage, low coverage, etc.), and/or (v) recent and/or expected life events (e.g., moving plans, travel plans, etc.), if any. At least some of the relevant information may be available to the insurance carrier, e.g., based upon the user profile associated with the user identified upon logging into the app. In one aspect, based upon the user's user profile, the server 160 may obtain user data such as name, address, date of birth, insurance policy/policies information (e.g., types of policies, account numbers, coverage information, items covered, etc.), as well as other suitable information. The insurance server 160 may request the information from the user via one or more of text (e.g., messaging, chat), voice (e.g., telephone call), videoconference, and/or any other suitable manner.

After the relevant information is obtained by the server 160 via the app or database 126, the server 160 may generate a recommended customized insurance policy 344. The generation of recommended customized insurance policy will be described below in details.

In one embodiment, the user may accept or reject the recommended customized insurance policy via selecting clickable icons 346 and 348. In another embodiment, the user may accept or reject the recommended customized insurance policy by responding in natural language. In response to the user accepting the recommended customized insurance policy, the server 160 may obtain customized code implementing the recommended customized insurance policy and deploy it to an insurance server, such as the server 180.

In the example according to FIG. 3B, in response to the user showing interest in having customized insurance policy, the server 160 may initiate an ML chatbot Cathy. The ML chatbot Cathy 330 may be a trained ML model stored on database 126 which the server 160 may load into MLOM 144 during the communication session 320b. Once initiated, ML chatbot Cathy 330 may request relevant information from the user in conversational nature via the app GUI 300. The content of the requests from the ML chatbot Cathy 330 are provided as text via the communication session 320b chat window. In one aspect, the ML chatbot Cathy 330 may also provide audio which may sound like a human speaking the requests. Generating the audio may include NLG of NLP module 148 to convert structured responses via ML chatbot Cathy 330 into natural conversational language.

In one aspect, the server 160 may analyze and/or process the request received by the chatbot 150 via the app to interpret, understand and/or extract relevant information within one or more responses from the user. In one aspect processing the claim information the chatbot 150 receives may include the NLP module 148 (e.g., the NLU and/or NLG modules), among other things. The chatbot 150 may also generate additional requests based upon the claim information it receives.

### Exemplary Method for Generating Customized Code

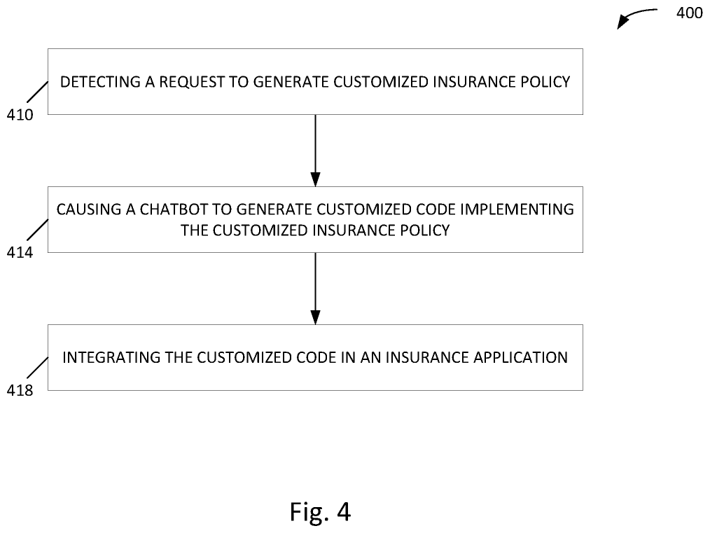

FIG. 4 depicts a flow diagram of an exemplary computer-implemented method 400 for generating customized code using a machine learning (ML) chatbot (or voice bot), according to one embodiment. One or more steps of the method 400 may be implemented as a set of instructions stored on a computer-readable memory and executable on one or more processors. The method 400 of FIG. 4 may be implemented via the exemplary computer environment 100A of FIG. 1A or exemplary computer environment 100B of FIG. 1B.

The computer-implemented method 400 may include: (1) at block 410 detecting, by one or more processors, a request from a user to generate a customized insurance policy; (2) at block 412 causing, by the one or more processors, a chatbot to generate customized code to be used in an insurance application, the customized code implementing the customized insurance policy; and/or (3) at block 414 generating, by the one or more processors, integrating the customized code in an insurance application.

In one embodiment, the insurance application comprising the customized code, when executed by one or more processors to: (1) receive user information from a user's mobile device or other computing device. (2) determine whether a change of insurance policy for the user is required, wherein the insurance policy is comprised in the insurance application, and/or (3) responsive to determining that a change of insurance policy is required, automatically update the insurance policy in the insurance application based upon the required change, and/or (i) create an update to the insurance policy, and/or (ii) send or transmit a proposed update to the insurance policy to the user's mobile device or other computing device for user review, modification, and/or approval. In one embodiment, as shown in FIG. 1A, the insurance application is executed by server 160. In another embodiment, as shown in FIG. 1B, the insurance application is executed by another server 180. In yet another embodiment, the insurance application is executed by the user device 102.

In one embodiment, a user may initiate the request to generate a customized insurance policy. The user may initiate the request by selecting “Request a New Policy” 314 shown in FIG. 3A-3C.

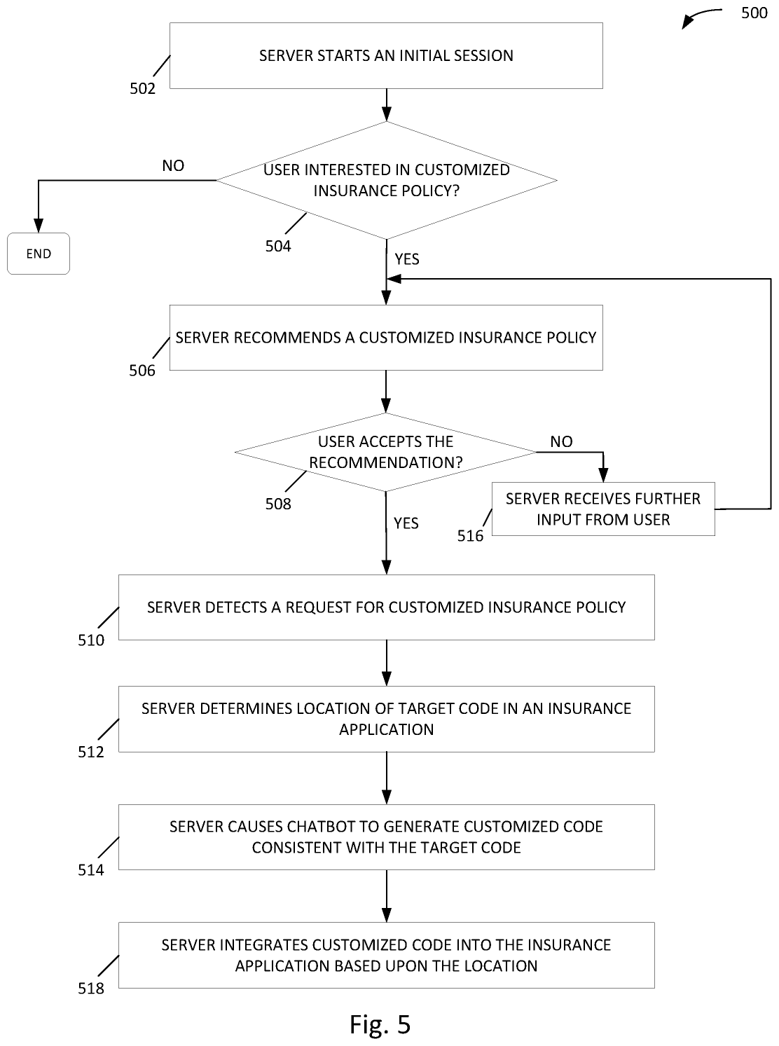

Referring now to FIG. 5, depicted is a flow diagram of an exemplary computer-implemented method 500 for generating customized code using a machine learning (ML) chatbot (or voice bot), according to another embodiment. One or more steps of the method 500 may be implemented as a set of instructions stored on a computer-readable memory and executable on one or more processors. The method 500 of FIG. 5 may be implemented via the exemplary computer environment 100A of FIG. 1A or exemplary computer environment 100B of FIG. 1B.

The method 500 begins at block 502 when the server 160 may start an initial session 320a. For example, the server 160 may start the initial session 320a if the server 160 determines, based upon the data collected by one or more user devices or the data stored in a database, there may be a change in the user's insurance needs. For example, when the user moves to a less safe region for a period of time, the user may need to increase his insurance coverage. For another example, when the user begins to exercise regularly, he may be entitled to a lower insurance premium. The data may be collected automatically by the user device via one or more functionalities comprised therein, the functionalities including a Global Positioning System (GPS), a gyroscope, a accelerometer, a heart rate sensor, a blood oxygen sensor, a compass, and a barometric altimeter, etc.

At block 504, in the initial session 320a, a user may or may not show interest in a customized insurance policy. If the user does not show interest in a customized insurance policy, the initial session 320a is terminated. The user may also indicate that they would never be interested in a customized insurance policy (e.g., by selecting “No and never.” 336 as shown in FIG. 3A). In that case, the server 160 may store the information in the user's profile and refrain from proposing a customized insurance policy to the user until the user initiates the request on their end.

In one embodiment, in the initial session 320b, if the user shows interest in a customized insurance policy, the server 160 may start a communication session 320b in which the chatbot 150 may serve to generate appropriate responses and collect information from the user's input. The user's input may be a non-standardized format dependent on the hardware (i.e., the user device) and software (e.g., the operating system of the user device) used by the user. For example, the user's input may be in a text format, in an audio format, in an image format, and/or in a video format. The server 160 may parse the inputs by the NLP functionality 148, an image analysis functionality (not shown), an audio analysis functionality (not shown), or a video analysis functionality (not shown) and convert the input or information included therein into a standardized format compliant with the database 126. For example, the input or information may be converted to a.csv format, a.db format, and/or be encrypted. The information stored in standardized format may be stored in the database 126 associated with the user, transmitted to a data analysis module for data analysis purposes, and/or used to train, retrain, fine-tune ML models. Alternatively, the chatbot 150 may parse the inputs and convert the inputs or information included therein into a standardized format.

In one embodiment, during the communication session 320b, if the user indicates in his response that he wishes to communicate with a human agent, the communication session 320b may be handed over from the chatbot 150 to a human agent. The human agent may collect and analyze information from on the communication, and send the information to the server 160.

At block 506, the server 160 may, via a data analysis module included in the ML functionality 140, prepare a recommended customized insurance based upon the information collected from the communication session 320b. The server may then recommend the customized insurance policy to the user via the chatbot 150 in the communication session 320b.

Alternatively, the chatbot 150 may, via a data analysis module included therein, prepare and recommend a customized insurance based upon the information collected from the communication session 320b.

The server 160 or the chatbot 150 may prepare the recommended insurance policy further based upon data stored in the database associated with the user, data associated with other users, data associated with existing or past insurance policies, the user's recent and/or expected life events, data associated with other users who have similar life events, and/or life events associated with other users who have similar profiles with the user.

In one embodiment, if the user accepts the recommended customized insurance policy, the server detects a request for generating the recommended customized insurance policy at block 510. If the user does not accept the recommendation, at block 516, the server may collect further information from the user via the chatbot 150 or a human agent.

In one embodiment, at block 512, the server 160 may access an insurance application used by the user. The server 160 may parse the code of the insurance application, locate the code that implements a current insurance policy for the user (i.e., the “target code”). Alternatively, the server 160 may locate the target code by parsing and analyzing the comments in the code via an NLP functionality. Alternatively, server 160 may locate the target code by analyzing the documentation associated with the code of the insurance application via an NLP functionality. Alternatively, server 160 may locate the target code by running and testing the code of the insurance application.

Upon locating the target code, at block 514, the server 160 may transmit the target code along with the request for customized code to the chatbot 150 and cause the chatbot 150 to generate customized code in a consistent manner with the target code. Alternatively, the server 160 may transmit the location of the target code to the chatbot 150 along with the request for customized code to the chatbot 150 and cause the chatbot 150 to generate customized code in a consistent manner with the target code. The chatbot 150 may be configured to retrieve the target code based upon location transmitted from the server 160.

In yet another embodiment, the chatbot 150 be configured to access the insurance application used by the user. The chatbot 150 may locate and retrieve the target code and generate code implementing customized insurance policy in a consistent manner. The chatbot 150 may locate the target code in the manners implemented by the server 160 described above.

In one embodiment, the server 160 may cause the chatbot 150 to generate multiple versions of customized for a human expert to select. For example, because the generative techniques implemented by the chatbot 150 may be non-causal, each time the chatbot 150 is prompted to produce the customized code, the resultant customized code may be slightly different. Thus, the server 160 may prompt the chatbot 150 to produce the customized code a predetermined number of time (e.g., one, two, three, five, etc.) to provide the options for the human expert to select.

Upon receiving customized code generated by the chatbot 150, at block 518, the server 160 may integrate the customized code into the insurance application used by the user. In one embodiment, at block 512, contemporaneously with or after the server 160 locates the target code, the server 160 may store the location of the target code. At block 518, the server 160 may integrate the customized code based upon the stored location. For example, the server 160 may replace the target code with the customized code generated by the chatbot 150. Alternatively, the server 160 may locate the code that invokes the target code (the “target invoking code”). The server 160 may then replace the target invoking code with code that invokes the customized code and add the customized code into in the application.

In another embodiment, the chatbot 150 may locate the target code prior to or contemporaneously with generating the customized code. The chatbot 150 may be trained to generate customized code and transmit the customized code along with the location of the target code. For example, the chatbot 150 may transmit the location of the target code in a manner that is compliant for use by the server 160. The chatbot 150 may transmit the customized code and the location of the corresponding current code in different files. Alternatively, the chatbot 150 may incorporate the location in the customized code in a comment format. The server 160 may parse the customized code and extract the location. The server 160 may then integrate the customized code into the insurance application in any of the manners described above. Alternatively, the chatbot 150 may locate the target invoking code and transmit it to the server 160 in the manners described above. The server 160 may then replace the target invoking code with code that invokes the customized code and add the customized code into in the application.

It should be understood that not all blocks of the exemplary flow diagrams 400 and 500 are required to be performed. Moreover, the exemplary flowcharts 400 and 500 are not mutually exclusive (e.g., block(s) from exemplary flow diagram 400 or 500 may be performed in any particular implementation).

### Exemplary Customized Code

The chatbot 150 may generate customized code. In one embodiment, the customized code, when executed by one or more processors, cause the one or more processors to implement a customized insurance policy. The customized insurance policy may include a customized insurance type, a customized insurance coverage, and/or a customized insurance premium.

In another embodiment, the customized code, when executed by one or more processors, cause the one or more processors to: (i) receive user information from a user device 102; (ii) determine whether a change of insurance policy for the user is required; and (iii) responsive to determining that a change of insurance policy is required, automatically update the insurance policy in the insurance application based upon the required change.

For example, the user information may comprise location of the user and time stamps associated with the location of the user. The customized code, when executed, may cause one or more processors to: (i) determine, based upon the user location and time stamps, whether there is a substantial change of location of the user for a significant period of time; and/or (ii) responsive to determining that there is a substantial change of location of the user for a significant period of time, automatically update the insurance policy in the insurance application based upon the change of location. The substantial change of location may be the user relocating to a region of lower safety, and a corresponding required change of insurance policy may be increasing the coverage of the insurance policy. The substantial change of location may be the user relocating to a region of higher safety, and a corresponding required change of insurance policy may be decreasing the coverage of the insurance policy. The substantial change of location may be the user relocating to another country, and a corresponding required change of insurance policy may be changing the coverage of the insurance policy or suspend the insurance policy.

For another example, the user information may comprise the user's activity data and/or health information. The customized code, when executed, may cause one or more processors to: (i) determine whether a change of the user information exceeds a predetermined threshold for an insurance policy change, and (ii) responsive to determining that the change of the user information exceeds the predetermined threshold, automatically update the user's insurance policy based upon the change. For example, if the user's activity data show that the user starts to exercise significantly more often, the user's medical insurance policy may be updated to decrease the user's premium.

In one embodiment, the customized code, when executed, may cause one or more processors to: (i) display the update of the user's insurance policy on the user device 102 for the user to approve; (ii) responsive to receiving the user's approval, update the user's insurance policy accordingly.

### Additional Considerations

As used herein, the term “user” may refer to a policyholder, a potential insurance customer, a person using an insurance application on behalf of a policyholder or a potential insurance customer.

Although the customized code described in the embodiments implements a customized insurance policy, it should be understood that the systems and methods disclosed herein may generate customized code implementing other customized contractual relationships and/or implementing actions for other needs.

Unless otherwise indicated, the processes implemented by an ML chatbot may be implemented by an ML voice bot, an AI chatbot, an AI voice bot, and/or a large language model (LLM).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

The systems and methods described herein are directed to an improvement to computer functionality, and improve the functioning of conventional computer systems.

What is claimed:

1. A computer system for generating customized code, the computer system comprising:
one or more processors; and
a non-transitory memory storing executable instructions thereon that, when executed by the one or more processors, cause the one or more processors to:
detect a request from a user to generate a customized insurance policy,
cause a machine learning (ML) chatbot to generate customized code to be used in an insurance application, wherein the customized code implements the customized insurance policy, and
integrate the customized code in the insurance application, wherein the customized code, when executed by one or more processors of an application server, cause the one or more processors of the application server to:
collect user information from a user device,
determine whether a change of insurance policy for the user is required, wherein the insurance policy is comprised in the insurance application, and
responsive to determining that a change of insurance policy is required, automatically update the insurance policy in the insurance application based upon the required change.

2. The computer system of claim 1, further comprising the application server.

3. The computer system of claim 1, wherein the executable instructions, when executed by the one or more processors, further cause the one or more processors to:
collect user information from the user device;
determine whether a change of the user information exceeds a predetermined threshold for an insurance policy change;
responsive to determining that the change of the user information exceeds the predetermined threshold, initiate an initial session allowing the user to customize an insurance policy; and
responsive to the user input to customize the insurance policy, generate a recommended insurance policy and present the recommended insurance policy to the user via the user device.

4. The computer system of claim 3, wherein to detect the request from the user to generate the customized insurance policy, the executable instructions, when executed by the one or more processors, further cause the one or more processors to:
detect that the user accepted the recommended customized insurance policy as the customized insurance policy.

5. The computer system of claim 3, wherein:
the system further comprises a data analysis module configured to process data in a standardized format; and
to generate the recommended insurance policy, the executable instructions, when executed by the one or more processors, cause the one or more processors to:
receive, via the user device, user input comprising user data, wherein the user input is in a non-standardized format;
convert the user data from the non-standardized format to the standardized format compliant to be used by the data analysis module;
transmit, to the data analysis module, the user data in the standardized format to generate an analysis result; and
responsive to receiving the analysis result, generate the recommended insurance policy based at least partially on the analysis result.

6. The computer system of claim 1, wherein to cause the ML chatbot to generate the customized code, the executable instructions, when executed by the one or more processors, further cause the one or more processors to:
locate target code in the insurance application, wherein the target code implements a current insurance policy for the user; and
cause the ML chatbot to generate the customized code in a similar format with the target code.

7. The computer system of claim 6, wherein causing the ML chatbot to generate the customized code further comprises transmitting the location of the target code to the ML chatbot.

8. The computer system of claim 1, wherein the customized code, when executed by the one or more processors of the application server, further cause the one or more processors of the application server to perform at least one of:
creating an update to the insurance policy; and
transmit a proposed update to the insurance policy to the user device for user review, modification, and/or approval.

9. The computer system of claim 1, wherein:
the user information comprises location of the user and a time stamp associated with the location of the user, and
the customized code, when executed by the one or more processors of the application server, further cause the one or more processors of the application server to:
determine whether there is a substantial change of location of the user for a significant period of time, and
responsive to determining that there is a substantial change of location of the user for a significant period of time, incorporate the substantial change of location into the required change of insurance policy.

10. The computer system of claim 9, wherein the substantial change of location comprises at least one of:
the user relocating to a region of lower safety,
the user relocating to a region of higher safety, and
the user relocating to another country,
the required change of insurance policy associated with the user relocating to the region of lower safety is to increase a coverage of the insurance policy,
the required change of insurance policy associated with the user relocating to the region of higher safety is to decrease the coverage of the insurance policy, and
the required change of insurance policy associated with the user relocating to another country is to change the coverage of the insurance policy or suspend the insurance policy.

11. The computer system of claim 1, wherein:
the user information comprises activity data of the user, and
the customized code, when executed by the one or more processors of the application server, further cause the one or more processors of the application server to:
determine whether a change of the user information exceeds a predetermined threshold for an insurance policy change, and
responsive to determining that the change of the user information exceeds the predetermined threshold, incorporate the change of the user information into the required change of insurance policy.

12. The computer system of claim 1, wherein the instructions, when executed by the one or more processors, further cause the one or more processors to:
cause the ML chatbot to generate a plurality of versions of customized code; and
send the plurality of versions of customized code to a human expert for selection.

13. The computer system of claim 1, wherein the instructions, when executed by the one or more processors, further cause the one or more processors to:
cause the ML chatbot to generate a plurality of versions of customized code; and
send the plurality of versions of customized code to a trained model for selection.

14. The computer system of claim 1, wherein the ML chatbot is trained with at least one of:
code compliant for use in the insurance application;
code associated with a prior demand related to insurance activities; and
code compliant for use for insurance activities.

15. A computer-implemented method for generating customized, the method comprising:
detecting, by one or more processors, a request from a user to generate a customized insurance policy,
causing, by one or more processors, a machine learning (ML) chatbot to generate customized code to be used in an insurance application, wherein the customized code implements the customized insurance policy, and
integrating, by one or more processors, the customized code in the insurance application, wherein the customized code, when executed by one or more processors of an application server, cause the one or more processors of the application server to:
collect user information from a user device,
determine whether a change of insurance policy for the user is required, wherein the insurance policy is comprised in the insurance application, and
responsive to determining that a change of insurance policy is required, automatically update the insurance policy in the insurance application based upon the required change.

16. The computer-implemented method of claim 15, further comprising:
collecting, by one or more processors, user information from the user device;
determining, by one or more processors, whether a change of the user information exceeds a predetermined threshold for an insurance policy change;
responsive to determining that the change of the user information exceeds the predetermined threshold, initiating, by one or more processors, an initial session allowing the user to customize an insurance policy; and
responsive to the user input to customize the insurance policy, generating a recommended insurance policy and present the recommended insurance policy to the user via the user device.

17. The computer-implemented method of claim 16, wherein detecting the request from the user to generate the customized insurance policy comprises:
detecting, by one or more processors, the user accepts the recommended customized insurance policy as the customized insurance policy.

18. The computer-implemented method of claim 16, wherein generating the recommended insurance policy comprises:
receiving, via the user device, user input comprising user data, wherein the user input is in a non-standardized format;
converting, by one or more processors, the user data from the non-standardized format to a standardized format compliant to be used by a data analysis module, the data analysis module configured to process data in a standardized format;
transmitting, to the data analysis module, the user data in the standardized format to generate an analysis result; and
responsive to receiving the analysis result, generating, by one or more processors, the recommended insurance policy based at least partially on the analysis result.

19. A computer readable storage medium storing non-transitory computer readable instructions for generating customized code, wherein the instructions when executed on one or more processors cause the one or more processors to:
detect a request from a user to generate a customized insurance policy,
cause a machine learning (ML) chatbot to generate customized code to be used in an insurance application, wherein the customized code implements the customized insurance policy, and
integrate the customized code in the insurance application, wherein the customized code, when executed by one or more processors of an application server, cause the one or more processors of the application server to:
collect user information from a user device,
determine whether a change of insurance policy for the user is required, wherein the insurance policy is comprised in the insurance application, and
responsive to determining that a change of insurance policy is required, automatically update the insurance policy in the insurance application based upon the required change.

20. A computer system for generating customized code, the computer system comprising:
one or more processors; and
a non-transitory memory storing executable instructions thereon that, when executed by the one or more processors, cause the one or more processors to:
detect a request from a user to generate a customized insurance policy,
cause an artificial intelligence (AI) chatbot to generate customized code to be used an the insurance application, wherein the customized code implements the customized insurance policy, and
integrate the customized code in the insurance application, wherein the customized code, when executed by one or more processors of an application server, cause the one or more processors of the application server to:
collect user information from a user device,
determine whether a change of insurance policy for the user is required, wherein the insurance policy is comprised in the insurance application, and
responsive to determining that a change of insurance policy is required, automatically update the insurance policy in the insurance application based upon the required change.
